(19) United States
(12) Patent Application Publication
(10) Pub. No.: US 2006/0064468 A1
(43) Pub. Date: Mar. 23, 2006

(54) Web services interface and object access framework

(76) Inventors: K. Ronald Brown, Oklahoma City, OK (US); David C. Kempf, Norman, OK (US); William H. Gentry, Kirkwood, MO (US)

Correspondence Address: CHARLES C. MCCLOSKEY, 763 S. NEW BALLAS ROAD STE. 170, ST. LOUIS, MO, 63141, US

(21) Appl. No.: 10/944,967

(22) Filed: Sep. 20, 2004

(51) Int. Cl. G06F 15/16

(52) U.S. Cl. 709/217

(57) ABSTRACT

The present invention serves as a framework for both an extensible markup language interface for web services and to access objects. Using web services and objects, the present invention allows two or more computer networks to communicate with each other regardless of the security status of the networks. The present invention collects information from the networks by classes of objects and transmits information between the networks without rendering a network less secure. The present invention is coded in the WSDL language and communicates upon the SOAP protocol.

### BACKGROUND OF THE INVENTION

The present invention relates to internet based software in general and more specifically to controlling communications between devices upon a network and devices outside of that network.

In the present day, computers and devices form and operate upon networks. A network has multiple computers or devices connected together for communication and in some cases, shared parallel processing of tasks. A network can be as small as two personal computers in an office or as large as or larger than multiple computers in a company across multiple states. A network can also include devices that communicate with each other and with a central base. In some areas of the country, electric utilities now have meters with antennae and computers that detect and communicate power consumption to a central computer for billing to customers. Whether made of computers, devices, or both, networks handle vast amounts of information. Networks that communicate with many computers and devices also likely contact the Internet in various ways. The volume of communications, computers, and devices coupled with the openness of the Internet raises the need for security. With multiple connections, a network on an odds basis alone, faces risk of being compromised from an unauthorized entity. A network then applies security measures for its protection from outsiders and for the individual components of the network.

Security measures take the form of passwords, usernames, restricted web sites, and restricted communications means, among other techniques. A network with security measures limits access to the network to only those computers and devices recognized as complying with the security measures. Computers and devices not in compliance do not access a network. Without access to a network, computers and devices may not transmit information regardless of meritorious intent or lack of malice. One network may have information required by a second network yet lack the security measures to gain access to the second network. A strong need exists for a system between two networks that maintains security upon both networks without compromising the security of either separate network.

### DESCRIPTION OF THE PRIOR ART

As the Internet has gained popularity and acceptance in the last decade, patent activity has just begun in this technical art. Relevant prior art includes mostly recent patent applications. The patent application No. 2002/0,046,239 to Stawikowski et al. describes a communication system of an automation equipment based on SOAP, or simple object access protocol. This system sends and receives messages over the Internet between a computer and a remote device.

Another patent application No. 2002/0,174,178 to Stawikowski et al. shows a communication system for automation equipment based on WSDL, or web services description language. This system executes a program upon the automation equipment and communicates with remote equipment executing its own programs.

Then the patent application No. 2003/0,118,353 to Baller et al. has a method and apparatus for managing intelligent assets in a distributed environment. This method manages remotely deployed equipment by communicating with and without wires.

Next, the patent application No. 2003/0,204,756 to Ransom et al. has a push communications architecture for intelligent electronic devices. These devices manage electrical power supply and distribution within a power grid system. The communications architecture allows reception of messages by a secure network from unsecured devices while maintaining the network as secure.

Networks regularly transmit data between separate parts. The data can be simple or complex. Complex data carries more information per a given unit of transmission. In web service clients, a complex data type is often implemented as a class with member fields of simple data types. Some languages and integrated development environments lack a concept of a class, structure, or record, and other means to describe complex data, thus, in those languages, complex data types cannot be processed. Note that, integrated development environments typically involve a desktop program that a programmer uses to write source code for networks and other programs. The programs include advanced text editors, compilers, debuggers, database managers, and installer programs integrated seamlessly. In the past, a programmer wrote code in an environment of these separate stand alone programs, all from different vendors.

### SUMMARY OF THE INVENTION

The present invention is a single interface for any software or firmware application that needs to connect, control, and consume data from any networked device or networked system of devices.

This single interface has an object oriented set of rules with subroutines and function calls, or methods, data definitions and data types, or properties. The present invention fits within other software applications as a Web Services Description Language (WSDL) Extensible Markup Language (XML) file: part of an XML web service application. The present invention handles a wide variety of data structures and data types accessible within any arbitrary networked device or networked system of devices.

Currently, many web service client systems do not allow polymorphic classes. As polymorphism becomes more widely available in web service client systems, the present invention will be ready. The Object Access Framework anticipates polymorphic behavior on the client side.

Numerous objects, features and advantages of the present invention will be readily apparent to those of ordinary skill in the art upon a reading of the following detailed description of presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved interface and framework for communication with both unsecured and secure devices.

Another object is to provide such a framework that has a single interface for connecting a software application or computer system to networks with varying communications protocols.

Another object is to have such a framework with a single interface to simplify connecting any software application to networks using multiple communication protocols.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 shows a schematic overview of the use of the preferred embodiment of the present invention;

FIG. 2 describes the interface of the present invention;

FIG. 3 shows a sequence diagram of diagnostic functions of the preferred embodiment;

FIG. 4 shows a sequence diagram of login functions of the preferred embodiment;

FIG. 5 shows a sequence diagram of object access functions also of the preferred embodiment;

FIG. 6 shows a sequence diagram of property value functions for the present invention;

FIG. 7 then shows a sequence diagram of group functions of the present invention; and, FIG. 8 shows another sequence diagram of run-time functions.

The same reference numerals refer to the same parts throughout the various figures.

### DESCRIPTION OF THE PREFERRED EMBODIMENT

In this description of the preferred embodiment, the following reference numerals are associated with these components:

| | |
|---|---|
| 10 | Client software application |
| 12 | SOAP protocol communications path |
| 14 | object access framework and web |
| | services interface |
| 15 | Programmer Interface |
| 16 | Communications Path |
| 17 | Communications Path |
| 18 | Vendor specific software application |
| 20 | Serial network communication path |
| 22 | Existing device network |
| 23 | Existing device network |
| 24 | Ethernet IP network |
| 26 | Ethernet IP communication path |
| 28 | Existing device network |
| 30 | WSDL interface |
| 32 | Core classes |
| 33 | Read and write messages |
| 34 | Web service methods |
| 35 | Diagnostic Web Methods |
| 36 | Version |
| 38 | GlxVersionInfo |
| 40 | Ping |
| 41 | Boolean |
| 42 | GetErrorInfo(string Token, string ID) |
| 44 | anyType |
| 45 | Authentication Web Methods |
| 46 | Login(GlxLogin ALogin) |
| 48 | GlxToken |
| 49 | Logout(GlxToken Token) |
| 50 | Boolean |
| 51 | Object Access Web Methods |
| 52 | GetObject(string Token, string |
| | ObjectID) |
| 54 | GlxObject |
| 56 | GetObjects(string Token, string ID) |
| 58 | GlxObjectArray |
| 60 | GetProperty(string Token, string |
| | PropertyID) |
| 62 | GlxProperty |
| 64 | GetProperties(string Token, string |
| | ObjectID) |
| 66 | GlxPropertyArray |
| 68 | GetMethod(string Token, string |
| | MethodID) |
| 70 | GlxMethodArray |
| 72 | GetMethods(string Token, string |
| | ObjectID) |
| 74 | GlxMethodArray |
| 75 | Property Value Web Methods |
| 76 | GetValue(string Token, string |
| | PropertyID) |
| 78 | GlxValue |
| 80 | GetValues(string Token, StringArray |
| | PropertyIDs) |
| 82 | GlxValueArray |
| 84 | GetValue2(string Token, string |
| | PropertyID) |
| 86 | anyType |
| 88 | GetValues2(string Token, StringArray |
| | PropertyIDs) |
| 90 | VariantArray |
| 92 | GetIndexedValues(string Token, string |
| | PropertyID, int StartIndex, int EndIndex) |
| 94 | VariantArray |
| 96 | GetDefaultValue(string Token, string |
| | ObjectID) |
| 98 | GlxValue |
| 100 | GetDefaultValues(string Token, string |
| | ObjectID) |
| 102 | GlxValueArray |
| 104 | GetDefaultValues2(string Token, string |
| | ObjectIDs) |
| 106 | GlxValueArray |
| 108 | GetPropertyValues(string Token, |
| | string ObjectID) |
| 110 | GlxValueArray |
| 112 | SetValue(stringToken, string |
| | PropertyID, anyType Value) |
| 114 | SetValues(string Token, StringArray |
| | PropertyIDs, VariantArray Values) |
| 118 | SetDefaultValue(string Token, string |
| | ObjectID, anyType Value) |
| 119 | Group Web Methods |
| 120 | AddGroup(string Token, string |
| | GroupID, string GroupName) |
| 122 | GlxGroup |
| 124 | AddGroupItem(string Token, string |
| | GroupID, string ID) |
| 126 | Boolean |
| 128 | AddGroupItems(string Token, string |
| | GroupID, StringArray IDs) |
| 130 | BooleanArray |
| 132 | GetGroupValues(string Token, string |
| | GroupID) |
| 134 | GlxValueArray |
| 136 | GetGroupValues2(string Token, string |
| | GroupID) |
| 138 | VariantArray |
| 140 | RemoveGroup(string Token, string |
| | GroupID) |
| 142 | Boolean |
| 143 | Run-Time Web Methods |
| 144 | InvokeMethod(string Token, string |
| | MethodID, VariantArray Args) |
| 146 | anyType |
| 148 | AddObject(string Token, string ID) |
| 150 | GlxIdentifier |
| 152 | RemoveObject(string Token, string ID) |
| 154 | Boolean |
| 156 | AddValue(string Token, string |
| | PropertyID, anyType Value) |

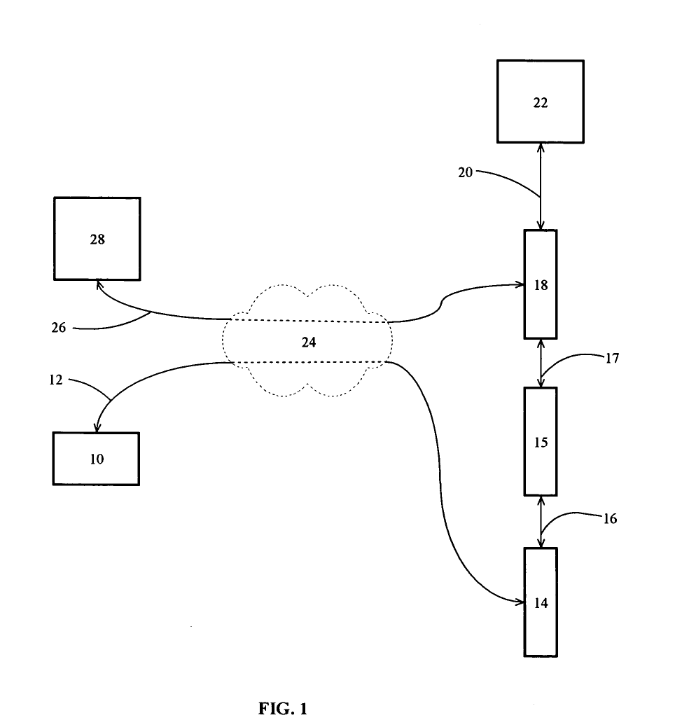

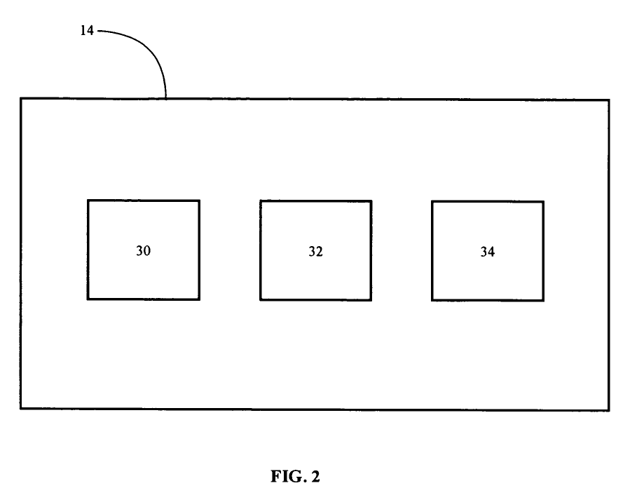

FIG. 1 shows a view of the uses of the object access framework and web services interface 14. A client software application 10 connects and communicates with the object access framework and web services interface 14 via an IP network 24 using the Simple Object Access Protocol, or SOAP path 12. The object access framework and web services interface 14 then connects and communicates via a path 16 to the programmer interface 15 which connects via another path 17 to the vendor specific software application 18. The application 18 directly communicates with the protocol specific device networks: for example, a device network using serial communications protocols 22 via a serial network communication path 20, and a device network 28 using IP communications protocols 26, such as TCP, UDP, SNMP via an IP network 24.

FIG. 2 shows a block diagram of the components inside the object access framework and web services interface 14. The first component is the Web Services Description Language or WSDL published interface 30. The WSDL interface 30 completely describes the web methods or functions, and return values for the web methods. The WSDL interface also describes the required parameters and their data types for the web methods, and the return value data types for those web methods that have a return value. The data types for the web methods and return values are within the standard types defined by the worldwide web consortium, or W3C. The object access framework and web services interface 14 has a second component, core classes 32, and the third component, Web Service Methods 34, where both data structures are described in the WSDL interface 30.

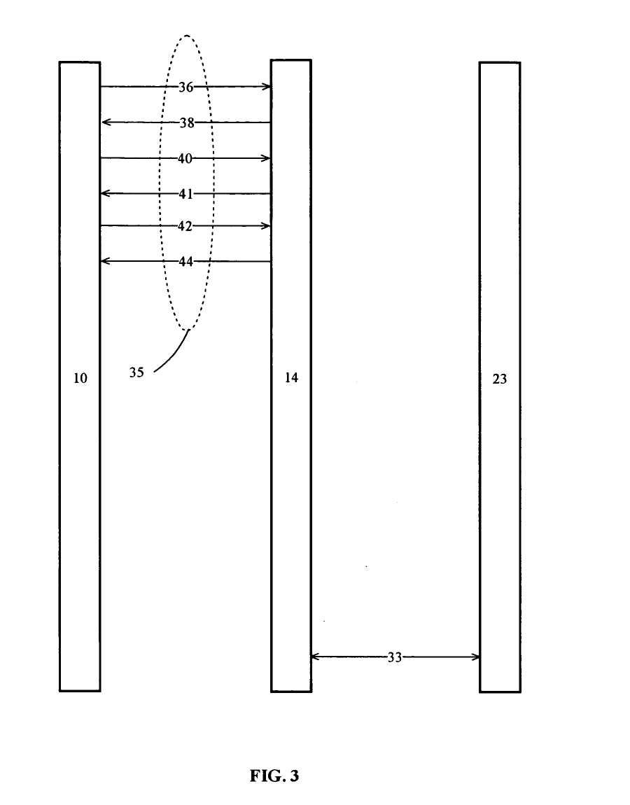

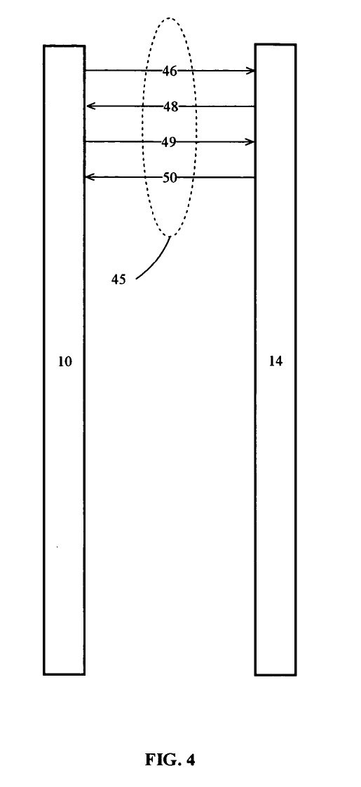

FIG. 3 shows the Diagnostic Web Methods 35 invoked by the client software application 10 via the framework 14 that communicate with the existing device network 23. Before logging into the framework 14, the client application 10 may interrogate the web services by calling the diagnostic web methods 35 and getting their return values. Version 36 is a Diagnostic Web Method that returns version information from the web services object access framework. GlxVersionInfo 38 is a return value for the Version 36 Web Method. GlxVersionInfo 38 is a class that describes version information for web services, or the framework 14. Ping 40 is a Diagnostic Web Method that tests if the web service returns the Boolean 41 value, True or False. GetErrorInfo(string Token, string ID) 42 is a Diagnostic Web Method that returns any errors encountered while trying to construct, load, or initialize an object or property. When the framework 14 does not control the device network specific objects, this may indicate a failure by the providing vendor. anyType 44 is the return value for the GetErrorInfo 42. Read and write messages 33 exchange information between the framework 14 and the existing device network 23.

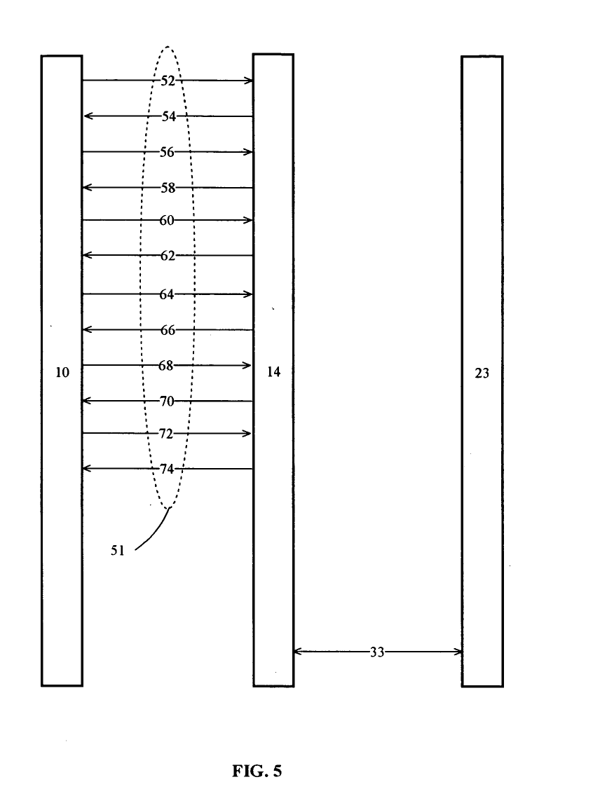

FIG. 4 shows the Authentication Web Methods 45 invoked by a client software application 10. Before using the web services, a user logs into the framework 14. The login process returns a token passed in every subsequent call to the framework 14. Login(GlxLogin ALogin) 46 is an Authentication Web Method called before accessing the framework 14 that the user must log into with a valid user name and password. This function returns a token required for passing to other web service methods. GlxToken 48 is the return value for the Login 46. Logout(GlxToken Token) 49 is an Authentication Web Method called when the user is done. At that instant, the user should log out. This releases any resources on the computer server allocated for the login session. The interface may automatically log out a user, often after a specified period of inactivity, and then the user will have to log in again. Boolean 50 is the return value for the Logout 49.

FIG. 5 shows the Object Access Web Methods 51 invoked by the client software application 10 via the framework 14 to communicate with the existing device network 23. These functions arise only after a successful login and a valid token is returned. ObjectIDs, PropertyIDs, and other IDs can be the current GlxIdentifier ID of the given node, or for compatibility and persistence across different instances of the object access framework web services, the fully qualified name of a GlxObject 54, GlxProperty 62, or GlxMethod. The string Token parameter is always the GlxToken 48 token field. GetObject(string Token, string ObjectID) 52 is an Object Access Web Method that returns a specific child object of the object identified by ObjectID. GlxObject 54 is the return value for GetObject 52. GetObjects(string Token, string ID) 56 is an Object Access Web Method that returns all of the child objects of the object identified by ObjectID. When ObjectID is an empty string, this function returns all the root level GlxObjects. A root level GlxObject 54 has no parent. GlxObjectArray 58 is the return value for GetObjects(string Token, string ID) 56 Web Method. GetProperty(string Token, string PropertyID) 60 is an Object Access Web Method that returns a specific property identified by PropertyID. GlxProperty 62 is the return value for the GetProperty 60. GetProperties(string Token, string ObjectID) 64 is an Object Access Web Method that returns all of the properties for the object identified by ObjectID. GlxPropertyArray 66 is the return value for the GetProperties 64. GetMethod(string Token, string MethodID) 68 is an Object Access Web Method that returns the specific method identified by MethodID. GlxMethodArray 70 is the return value for GetMethod 68. GetMethods(string Token, string ObjectID) 72 is an Object Access Web Method that returns all of the methods for the object identified by ObjectID. GlxMethodArray 74 is the return value for GetMethods 72. Read and write messages 33 again are exchanged between the framework 14 and the existing device network 23.

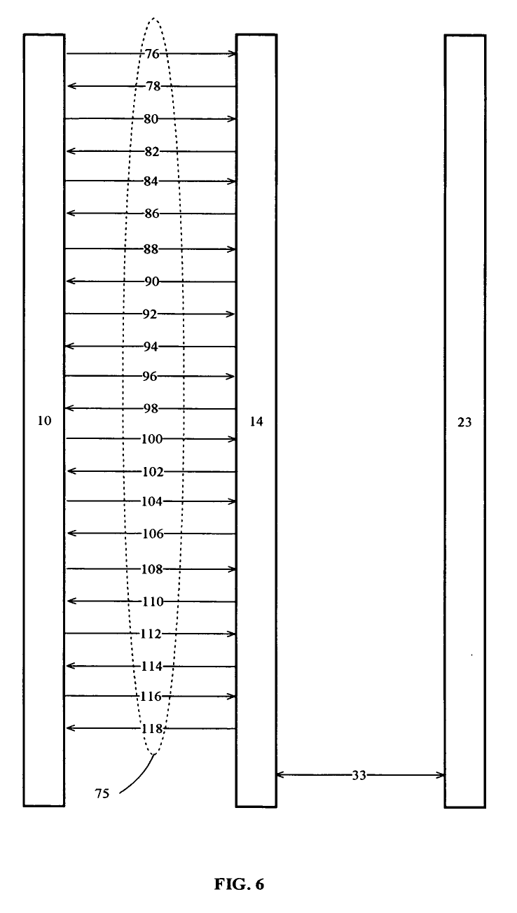

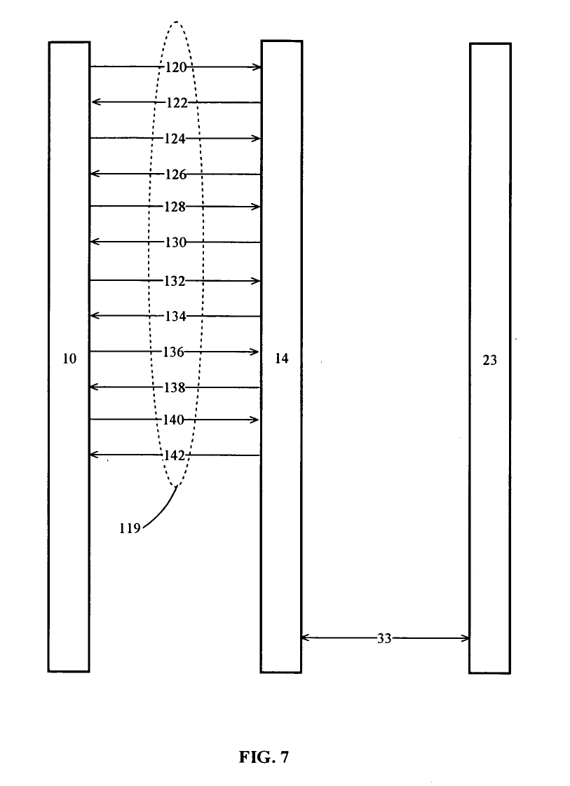

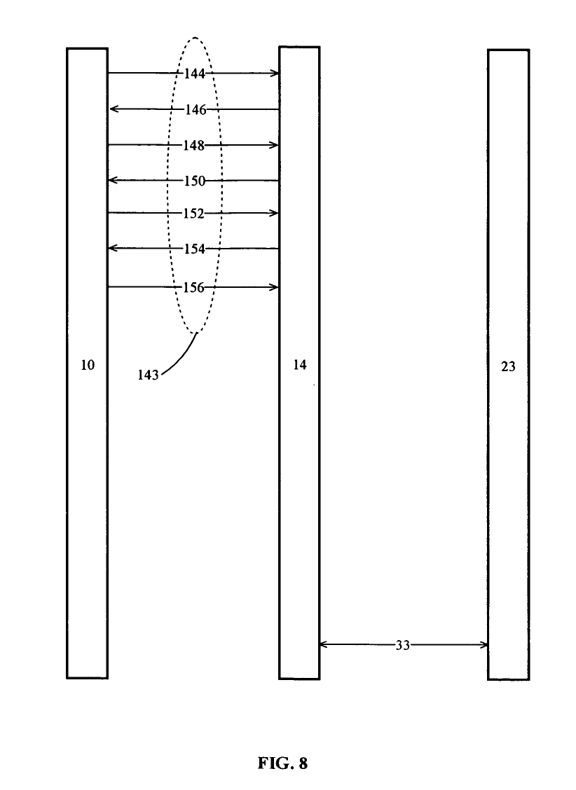

FIG. 6 shows the Property Value Web Methods 75 that are invoked by the client software application 10 via the framework 14 in communication with the existing device network 23. These functions allow the user to get and to set the values of single and multiple properties, and to get or to set the default property value of a GlxObject 54. A valid GlxToken 48 is required for each call. GetValue(string Token, string PropertyID) 76 is a Property Value Web Method that returns the value of the property identified by PropertyID 76. GlxValue 78 is the return value for the GetValue 76. GetValues(string Token, StringArray PropertyIDs) 80 is a Property Value Web Method that returns the values of the properties identified by an array of PropertyIDs. GlxValueArray 82 is a return value for the GetValues 80. GetValue2(string Token, string PropertyID) 84 is a Property Value Web Method that returns just the xsd:anyType 86 return value of the property identified by PropertyID in the GetValue2 84. GetValues2(string Token, StringArray PropertyIDs) 88 is a Property Value Web Method that returns an array of xsd:anyType 86 values for the properties identified by an array of PropertyIDs, see also the Group Web Methods 119 as later shown in FIG. 7. VariantArray 90 is a return value for GetValues2 88.

GetIndexedValues(string Token, string PropertyID, int StartIndex, int EndIndex) 92 is a Property Value Web Method that returns an array of xsd:anyType 86 values for the Indexed Array Property identified by PropertyID. StartIndex and EndIndex specify the range to get in the Indexed Array. VariantArray 94 is the return value for the GetIndexedValues 92. GetDefaultValue(string Token, string ObjectID) 96 is a Property Value Web Method that is a convenience function. By default, this function simply returns the object's Identifier. Name. Many GlxObjects override this behavior and specify a different default property and return the value of the default property for the object identified by ObjectID which is GlxValue 98. GetDefaultValues(string Token, string ObjectID) 100 is a Property Value Web Method and a convenience function that returns the default values of all child objects for the object identified by ObjectID and returned via GlxValueArray 102 which is the return value for GetDefaultValues 100. GetDefaultValues2(string Token, string ObjectIDs) 104 is a Property Value Web Method and a convenience function that returns the default values for all the objects specified in the array ObjectIDs via the GlxValueArray 106 return value for GetDefaultValues2 104. GetPropertyValues(string Token, string ObjectID) 108 is a Property Value Web Method that returns all the values of all the properties of the object identified by ObjectID via GlxValueArray 110 which is the return value for GetPropertyValues 108. SetValue(stringToken, string PropertyID, anyType Value) 112 is a Property Value Web Method that assigns a value to the property identified by PropertyID and does not have a return value. For most properties, the type of Value must be the same type as would be obtained from a call to GetValue 76.

Often simple type conversions can be done by the framework 14 such as from string to float. SetValues(string Token, StringArray PropertyIDs, VariantArray Values) 114 is a Property Value Web Method that assigns values to multiple properties identified by the array PropertyIDs and does not have a return value. SetValue 112 restricts the data type of the elements of values that must be passed. SetIndexedValues(string Token, string PropertyID, int StartIndex, VariantArray Values) 116 is a Property Value Web Method that assigns values to the Array Property identified by PropertyID and does not have a return value. StartIndex specifies where in the Array Property to start writing. The size of the Values array determines how many elements of the Array Property are written. SetDefaultValue(string Token, string ObjectID, anyType Value) 118 is a Property Value Web Method and a convenience function that assigns a value to the default property of a GlxObject 54, if it is defined. The same restrictions on the data type of Value exist as in SetValue 112. SetDefaultValue(string Token, string ObjectID, anyType Value) 118 does not have a return value. As before, read and write messages 33 cross back and forth between the framework 14 and the existing device network 23.

FIG. 7 shows the Group Web Methods 119 that are invoked by the client software application 10 via the framework 14 also to communicate with the existing device network 23. These convenience functions within the framework 14 provide the user the ability to define groups of objects and properties for convenient access based on a GroupID. After a group is defined, the values of the properties and the default values of the objects can be retrieved in a single method call. Similar functions arise in the web service method GetValues2 88. AddGroup(string Token, string GroupID, string GroupName) 120 is a Group Web Method that defines a new group. Groups can be nested and so the optional GroupID parameter can specify the parent Group of a Group. GlxGroup 122 is the return value for the AddGroup 120. AddGroupItem(string Token, string GroupID, string ID) 124 is a Group Web Method for adding a single object (default property) or property to the group identified by GroupID. Boolean 126 is the return value for the AddGroupItem 124. AddGroupItems(string Token, string GroupID, StringArray IDs) 128 is a Group Web Method that adds multiple objects and properties to the group identified by GroupID.

BooleanArray 130 is the return value for the AddGroupItems(string Token, string GroupID, StringArray IDs) 132 Web Method. GetGroupValues 132 is a Group Web Method that returns all the Values of the members of the group (value of GlxProperty 62 members, default value for GlxObject 54 members). GlxValueArray 134 is the return value for the GetGroupValues 132. GetGroupValues2(string Token, string GroupID) 136 is a Group Web Method that returns all the values of the members of the group (value of GlxProperty 62 members, default value for GlxObject 54 members) as an array of xsd:anyType 86. VariantArray 138 is a return value for the GetGroupValues2 136. RemoveGroup(string Token, string GroupID) 140 is a Group Web Method that removes a previously defined group. Group 140 returns a Boolean value 142 as TRUE if successful, and throws an exception otherwise. Read and write messages 33 cross between the framework 14 and the existing device network 23.

FIG. 8 shows the Run-Time Web Methods 143 that are invoked by the client software application 10 via the framework 14 to communicate with the existing device network 23. Some objects in the framework 14 object hierarchy provide dynamic behavior. The Run-Time Web Methods 143 make this behavior available to the end user. InvokeMethod(string Token, string MethodID, VariantArray Args) 144 is a Run-Time Web Method that invokes the object method identified by MethodID. Returning briefly to FIG. 5, the GlxObject's 54 sets requirements for Args—arguments—invoking the particular method that has previously described effects, and the return value also has a previously described meaning. anyType 146 is the return value for the InvokeMethod 144. AddObject(string Token, string ID) 148 is a Run-Time Web Method that some objects support for the dynamic construction of child objects while the framework 14 runs. In general, this feature will only apply to objects whose child objects are all of the same type, or parent objects that have a typical child object. GlxIdentifier 150 is the return value: a new child object if the object supports this feature and successfully constructs a new child object, or otherwise, an exception for AddObject 148. RemoveObject(string Token, string ID) 152 is a Run-Time Web Method that removes a previously constructed object that returns Boolean 154 as TRUE if successful. AddValue(string Token, string PropertyID, anyType Value) 156 is a Run-Time Web Method that adds a new property value to an Array Property and does not have a return value. As before, read and write messages 33 travel between the framework 14 and the existing device network 23.

After listing and describing the parts of the preferred embodiment, the preferred embodiment operates with core classes and web service methods. To use the object access framework's web services, one skilled in the art has familiarity with the classes passed to and from the interface function calls. The classes provide the foundation for the object access framework and build wide scale applications and services. A glossary of class terms is provided as appendix A to this disclosure.

From the aforementioned description, a web services interface and object access framework has been described. The framework is uniquely capable of communicating and processing information both to and from a client application upon a computer and a separate network whether secured or not. The web services interface and object access framework and its various components may be may be written in many programming languages, including but not limited to, assembly, FORTRAN, C++, Pascal, Visual Basic, HTML, JAVA, WSDL, and XML and may be installed upon many computers including, but not limited to, mainframes, minicomputers, microcomputers, desktops, portable digital assistants, and networks.

The phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

The source code for the present invention is provided as appendix B. The glossary of terms for the present invention is provided as appendix A.

### APPENDIX A

Glossary of terms for the present invention of the web services interface and object access framework:

GlxParameter—An instance of this class describes argument or parameter information to and for a GlxMethod. It includes the following fields:

GlxIdentifier Identifier—Uniquely identifies the parameter in the Framework's hierarchy.

boolean is optional—Indicates that the presence of the parameter is optional when invoking the GlxMethod via the InvokeMethod Web Service method.

xsd:AnyType DefaultValue—For optional parameters, the value assumed for the parameter when it is not present when invoking the GlxMethod.

GlxTypeInfo TypeInfo—Describes type information of the parameter.

GlxMethod—Some objects in the Framework's Object Hierarchy support or provide dynamic behavior. A GlxMethod exposes a specific behavior for a GlxObject via the InvokeMethod Web Service method. The class includes the following fields:

GlxIdentifier Identifier—Uniquely identifies the method in the Framework's hierarchy.

GlxParameterArray Parameters—An array describing the required and optional parameters in the Args argument to the InvokeMethod Web Service call.

string Description—Additional information about the method.

string IFace—Some methods belong to a defined set of methods known as an interface. If the GlxMethod is a member of such an interface, this property names it.

GlxTypeInfo ReturnType—Describes return type information of the method when the method is called or invoked via the InvokeMethod Web Service method.

A call to the InvokeMethod Web Service method is analogous to invoking a class or instance method in a traditional programming language. You supply the GlxMethod fully qualified name, and an array of xsd:AnyType whose types match the corresponding GlxParameter in the Parameters array. A GlxMethod is not necessarily web service method itself, although it could be implemented as one. See the InvokeMethod Web Service method for more information.

GlxRem—This class is defined in order to have a common ancestor for all framework's complex remotable types. It has no properties or methods. All GlxXXX types descend from this class.

GlxLogin—An instance of this class is required to login to Framework's Web Services. It consists of 4 fields:

string Username—A valid username with access rights to login to Framework's Web Services. Users and passwords are part of the web service configuration.

string Password—The correct password for the specified username.

int LocaleID—Requests that the service provide locale specific text messages.

GlxSessionOptions Options—This field provides some configurable session options per user login.

GlxToken—An instance of this class or the contents of the member field Token is returned from the Login function. All subsequent calls to the web service and all object access methods require that this token be returned on every call. It provides authentication information. This class contains a single field:

string Token—Simply the necessary information for authentication.

GlxIdentifier—Used to uniquely identify objects, properties, and methods in the Framework's Object hierarchy. It consists of following fields:

string ID—A unique identifier in all the Framework's Object hierarchy. The ID is generated at runtime by the Framework's Web Services. It is very likely that the ID's will not remain the same between different instances of the Web Services.

string Name—A name for the object or property, usually unique among all the objects or properties of a GlxObject. Uniqueness in an object's name means that the object can be referenced by its fully-qualified object name between distinct running instances of Framework's Web Services.

string DisplayName—Another name for the object or property, suitable for display purposes. This name is user definable via the SetDisplayName web method described below.

int Index—Additional description information which may be used for ordering.

GlxMemberScope Scope—An enumerated value describing the scope of a member inside its owner

int TypeID—An optional type identifier. If defined, the object type will appear in the GlxClassRegistry, one of the many predefined framework Objects.

A fully-qualified object, property, or method name is the fully-qualified name of the object's, property's, or method's parent, followed by a delimiting character (the forward slash character (‘/’)), followed by the object's, property's, or method's own GlxIdentifier.Name. Every fully-qualified object, property, or method name is also prepended with two delimiting characters (forward slashes). In general, fully-qualified names are case sensitive. In practice, an object's, property's, or method's GlxIdentifier.Name is unique among its siblings.

For example, an object might have a fully qualified name of //EnNET-Modbus/Servers/192.168.1.15_{—}1, which might address a Modbus TCP/IP device. The fully-qualified name //EnNET-Modbus/Servers/192.168.1.15_{—}1/HoldingRegisters might address the indexed array property of a Modbus TCP/IP device's Holding Registers table.

References to elements of an indexed array property are the same as the reference to the indexed array property itself, followed by the forward slash character, followed by the index of the element of interest. For instance, //EnNET-Modbus/Servers/192.168.1.15_{—}1/HoldingRegisters/105 might refer to the 105th element of the Holding Registers table of a Modbus TCP/IP device.

Objects, properties, and methods can all be referenced in Framework's Web Service calls by either their GlxIdentifier.ID or their fully-qualified name. The GlxIdentifier.ID is likely to change between running instances of the Framework's Web Services.

GlxNode—This class provides a common ancestor for all the discrete components in the Framework. The structure of the Framework's Object Access Framework is tree-like in nature, and a common ancestor for components makes for convenient and easy implementation. This class has no member fields. If you define in this class (or any other) custom member functions or properties in a client application, remember that many IDE's will automatically overwrite changes you make to files generated by a WSDL importer.

GlxObject—A single component or object in the Object Framework. It includes the following fields:

GlxIdentifier Identifier—Uniquely identifies this object in the Framework's hierarchy.

int ObjectCount—The number of child GlxObjects owned by the object.

int PropertyCount—The number of properties of the object

int MethodCount—The number of GlxMethods of the object.

string DefaultProperty—The name of the default property of the object (a property whose Value is Gettable/Settable by the Get/SetDefaultValue web methods for GlxObjects).

anyType Interfaces—An optional list of supported interfaces

A GlxObject contains or owns an optional list of sub-objects or child GlxObjects, an optional list of GlxProperties, and an optional list of GlxMethods. These lists are obtained through separate Web Service methods, rather than as members of this class, to make access to the possibly huge tree of objects both network and resource friendly. A value greater than 0 for any of the counts indicates that the list is defined.

It is anticipated that the consumer of Framework's Web Services may want to build his own local tree image that reflects the structure of the Framework's Object Tree. It can be easily built with just two of the provided web service methods. As or after the tree image is built, getting or setting the current value of a particular property is very simple indeed. Gridlogix has examples in many languages to assist in guiding the developer through the process.

Example: A GlxObject might provide access to the configuration of a Modbus device, or access to a single database, table or row in a database server.

GlxRange—A class used to describe the high and low values in a range of integers. It contains the two fields:

int Low—the low value in the range.

int High—the high value in the range.

GlxProperty—This class usually describes a single point of data within the Object Framework. It may also describe an array of same type data points, in which case it is referred to as an Array Property. When a particular array property has so many elements that they can't be enumerated (or has an undetermined number of elements), then the array property is an Indexed Array Property, and values read from it must be accessed via specified indices. GlxProperty includes the following fields:

GlxIdentifier Identifier—Uniquely identifies this property in the Framework's hierarchy.

GlxAccessRight AccessRight—An enumerated value describing the logged in user's access rights to the property.

string Description—Additional information about the property.

GlxTypeInfo TypeInfo—Describes the expected data type of the value of the property.

boolean Indexed—A value of true for this field indicates that the property is an indexed array property, and that the value of the property must be accessed using indices through the GetIndexedValues web service method.

GlxRange Indices—For Array Properties and Indexed Array Properties, the range of valid indices.

String Units—An optional descriptive field.

Example: A GlxProperty might provide access to the Coils table in a Modbus device, the present value of a BACnet Analog Output, or access to a field of a row in a database table.

GlxTypeInfo—This class describes data type information for the expected value of a GlxProperty. It includes the following fields:

word VarType—A number describing the data type. This is usually the OLE compatible variant data type.

int Low, High—For enumerated types and for integer sub-range type, these two numbers describe the valid range of integer values.

xsd: anyType Names—Optional symbolic names for enumeration or set data types.

word ArrayType—A number describing the data type of individual members of an array data type.

Example: A GlxTypeInfo instance might describe the boolean data type. In this case, the VarType would be 11 (OLE variant type), Low would be 0, High would be 1, and Names would be a string array containing [“False”, “True”]. ArrayType would be 0, indicating that the boolean data type is not an array.

GlxValue—Any object access framework has to describe the value or data associated with any given property. The framework does so with GlxValue. It includes the following fields:

word DataType—A number describing the type of the data, usually OLE compatible.

dateTime Timestamp—The time that the data present was obtained.

GlxDataSource DataSource—An enumerated value indicating the origin of the data.

xsd:anyType: Value—The data itself. In clients on Win32 platforms, the anyType is often implemented as a variant. In some environments that support polymorphism, it may implemented or defined as a simple object. No matter the consumer's environment, Value will always be simple data types, or arrays of simple data types.

int ErrorID—An optional number describing the type of error encountered when trying to access the value of a property.

int QualityID—An optional number describing the quality of the data present.

More than likely, if an error is encountered trying to fetch the value of a GlxProperty, an exception will be thrown. Extended error and quality information may be obtained through separate web service methods.

Example: A GlxValue might provide the values [True, False, True] for the first three Coils of a Modbus device, the value 3.1415926 read from a BACnet Analog Input, or a digital blob from the Picture field in a database row.

GlxGroup—Framework's Web Services provide the user the ability to define groups of objects and properties for convenient access based on a GroupID. After a group is defined, the values of all the properties and the default values of all the objects can be retrieved in a single method call. GlxGroup is a GlxObject that may have additional fields that are specific to different versions of the Framework's Web Services.

GlxVersionInfo—This class describes version information for the Framework's Web Services. The fields of this class are subject to change between different versions of the frameworks.

The Web Service Methods—exposes the following interface. The interface methods can be loosely categorized in the following functional groups:

Diagnostics Login Object Access Property Value Group Run-Time Other

Diagnostic Functions—Before logging in to Framework's Web Services, you may want to find out a little bit about the service.

GlxVersionInfo

Version( )—Returns version information from a running instance of the Framework's Web Services.

Boolean

Ping( )—A convenience function to test to see if the web service is available.

anyType

GetErrorInfo(string Token, string ID)—Return any errors encountered trying to construct, load, or initialize an object or property. When the framework does not control the platform specific objects, this may indicate a failure by the providing vendor.

Login Functions—When the user is ready to use the service he must login. The login process returns a token which must be passed in every subsequent call to the Framework's Web Services.

GlxToken

Login(GlxLogin ALogin)—Before accessing the Object Framework, a user must login with a valid user name and password. This function returns a token required and suitable for passing to nearly every other web service method.

boolean

Logout(GlxToken Token)—When the user is done, he should log out. This will release any resources on the server allocated for the login session. A user may be automatically logged out after a specified period of inactivity, or for other reasons, in which case he'll have to log in again.

Object Access Functions—The following functions provide easy access to the Object Access Framework. They are available only after a successful login, and a valid token is returned. ObjectIDs, PropertyIDs, and other IDs can be the current GlxIdentifier. ID of the given node, or for compatibility and persistance across different instances of Framework's Web Services, the fully qualified name of a GlxObject, GlxProperty, or GlxMethod. The string Token parameter is always the GlxToken.Token field.

GlxObject

GetObject(string Token, string ObjectID)—Return a specific child object of the object identified by ObjectID.

GlxObjectArray

GetObjects(string Token, string ID)—Return all of the child objects of the object identified by ObjectID. When ObjectID is an empty string, this function returns all the root level GlxObjects. A root level GlxObject has no parent.

GlxProperty

GetProperty(string Token, string PropertyID)—Return a specific property identified by PropertyID.

GlxPropertyArray

GetProperties(string Token, string ObjectID)—Returns all the properties for the object identified by ObjectID.

GlxMethodArray

GetMethod(string Token, string MethodID)—Returns the specific method identified by MethodID.

GlxMethodArray

GetMethods(string Token, string ObjectID)—Returns all the methods for the object identified by ObjectID.

Property Value Functions—The following functions allow the user to get and set the value or values of single and multiple GlxProperties, and to get or set the default property value of a GlxObject. A valid GlxToken is required for each call.

GlxValue

GetValue(string Token, string PropertyID)—Returns the value of the property identified by PropertyID.

GlxValueArray

GetValues(string Token, StringArray PropertyIDs)—Returns the values of the properties identified by an array of PropertyIDs.

anyType

GetValue2(string Token, string PropertyID)—Returns just the xsd:anyType value of the property identified by PropertyID.

VariantArray

GetValues2(string Token, StringArray PropertyIDs)—Returns an array of xsd:anyType values for the properties identified by an array of PropertyIDs. See also the Group Functions below.

VariantArray

GetIndexedValues(string Token, string PropertyID, int StartIndex, int EndIndex)—Returns an array of xsd:anyType values for the Indexed Array Property identified by PropertyID. StartIndex and EndIndex specify the range to get in the Indexed Array.

GlxValue

GetDefaultValue(string Token, string ObjectID)—A convenience function. By default, this simply returns the object's Identifier.Name Many GlxObjects override this behavior and specify a differennt default property. Returns the value of the default property for the object identified by ObjectID.

GlxValueArray

GetDefaultValues(string Token, string ObjectID)—A convenience function. Returns the default values of all child objects for the object identified by ObjectID.

GlxValueArray

GetDefaultValues2(string Token, string ObjectIDs)—A convenience function. Returns the default values for all the objects specified in the array ObjectIDs.

GlxValueArray

GetPropertyValues(string Token, string ObjectID)—Return all the values of all the properties of the object identified by ObjectID.

SetValue(stringToken, string PropertyID, anyType Value)

Assigns Value to the property identified by PropertyID. For most properties, the type of Value must be the same type as would be obtained from a call to GetValue. Oftentimes, simple type conversions can be done by Framework's Web Services (from string to float, e.g.).

SetValues(string Token, StringArray PropertyIDs, VariantArray Values)—Assign Values to multiple properties identified by the array PropertyIDs. See SetValue for restrictions on the data type of the elements of Values that must be passed.

SetIndexedValues(string Token, string PropertyID, int StartIndex, VariantArray Values)—Assign Values to the Array Property identified by PropertyID. StartIndex specifies where in the Array Property to start writing. The size of the Values array determines how many elements of the Array Property are written.

SetDefaultValue(string Token, string ObjectID, anyType Value)—A convenience function. Assigns Value to the default property of a GlxObject, if it is defined. The same restrictions on the data type of Value exist as for calls to SetValue.

Group Functions—These are convenience functions. The framework's Web Services provide the user the ability to define groups of objects and properties for convenient access based on a GroupID. After a group is defined, the values of all the properties and the default values of all the objects can be retrieved in a single method call. Similar functionality is supported in the web service method GetValues2.

GlxGroup

AddGroup(string Token, string GroupID, string GroupName)—Defines a new group. Groups can be nested and so the optional GroupID parameter can specify the parent Group of a Group.

boolean

AddGroupItem(string Token, string GroupID, string ID) add a single object (default property) or property to the group identified by GroupID.

BooleanArray

AddGroupItems(string Token, string GroupID, StringArray IDs)—Add multiple objects and properties to the group identified by GroupID.

GlxValueArray

GetGroupValues(string Token, string GroupID)—Returns all the Values of the members of the group (value of GlxProperty members, default value for GlxObject members).

VariantArray

GetGroupValues2(string Token, string GroupID)—Returns all the values of the members of the group (value of GlxProperty members, default value for GlxObject members) as an array of xsd:anyType.

boolean

RemoveGroup(string Token, string GroupID)—Remove a previously defined group. Returns true if successful, and throws an exception otherwise.

Run-Time Functions—Some objects in the Framework's Object Hierarchy support or provide dynamic behavior. The following functions make this behavior available to the end-user.

anyType

InvokeMethod(string Token, string MethodID, VariantArray Args)—Invoke the object method identified by MethodID. See the GlxObject's individual documentation for the requirements of Args, the effect that invoking the particular method will have, and the return value meaning.

GlxIdentifier

AddObject(string Token, string ID)

Some objects support the dynamic construction of child objects while the service is running. In general, this feature will only apply to objects whose child objects are all of the same type, or objects that have a typical child object. Return a new child object if the object supports this feature and successfully constructs a new child object; throws an exception otherwise.

boolean

RemoveObject(string Token, string ID)—Remove a previously constructed object. Returns true if successful.

AddValue(string Token, string PropertyID, anyType Value)—Add a new property value to an Array Property.

Other Functions—

GlxNode

GlxRem

We claim:

1. A method of communicating and transmitting information between a client application on a computer or network of computers and an external device as a single device or member of a device network where a device includes a computer, where the improvement comprises:
an interface of software programmed upon a computer, said interface allowing two way communication of data without breaching security;
whereby said interface allows and assists the client application to communicate with an external device or network.

2. The method of claim 1 further comprising:
said interface operating upon the WSDL and communicating via SOAP.

3. The method of claim 2 further comprising:
said interface being adaptable to an XML environment for deployment over the internet.

4. A method of communicating and transmitting information between two or more computers, the computers forming a network, comprising:
a client application on a computer;
an external computer; and,
an interface residing upon a computer as software, wherein two way communication of data occurs between said client application and said external computer without breaching security of said client application, said external computer, and said interface;
said interface issuing web method queries from said interface to said external computer on behalf of said client application, receiving returns from said external computer, analyzing said returns, and transmitting results of the analysis to said client application;
whereby, information passes among said client application through said interface to said external computer without breaching the security protocols of said client application and said external computer.

5. The communication method of claim 4 wherein said web methods comprise software objects, either parent or child, singly or in groups that pass information between said client application and said external device.

6. A method of communicating and transmitting information between a client application and an external computer upon separate computer networks, comprising:
an interface having software, wherein two way communication of data occurs between said client application and said external computer without breaching security of said client application, said external computer, and said interface;
said interface issuing web method queries using objects and groups from said interface to said external computer on behalf of said client application, receiving returns from said external computer, analyzing said returns, and transmitting results of the analysis to said client application;
whereby, information passes from said client application through said interface to said external computer without breaching the security of said client application and said external computer.

7. The communication method of claim 6 wherein said interface diagnoses operating and communicating protocols of said client application and said external computer thus permitting secure information transmission.

8. The communication method of claim 6 wherein said interface authenticates the digital identity of said client application and said external device whereby successful authentication opens communication, establishes communication of groups, and activates run time communication, all between said client application and said external device.
